(19) United States
(12) Patent Application Publication
(10) Pub. No.: US 2013/0088736 A1
(43) Pub. Date: Apr. 11, 2013

(54) IMAGE FORMING APPARATUS, IMAGE FORMING METHOD AND COMPUTER-READABLE MEDIUM

(71) Applicant: CANON KABUSHIKI KAISHA, Tokyo (JP)

(72) Inventor: Takeshi Kaneda, Yokohama-shi (JP)

(73) Assignee: CANON KABUSHIKI KAISHA, Tokyo (JP)

(21) Appl. No.: 13/633,927

(22) Filed: Oct. 3, 2012

(30) Foreign Application Priority Data
Oct. 7, 2011 (JP) 2011-223455

(51) Int. Cl. G06K 15/02

(52) U.S. Cl. 358/1.13

(57) ABSTRACT

An image forming apparatus which is connected to an external device and prints a PDL file managed in the external device, comprises: an acquisition unit that acquires a size of a file to be printed; a comparison unit that compares a size storable in a reception buffer of the image forming apparatus with the size of the file; and a network mount unit that mounts a folder of the external device containing the file, wherein the network mount unit mounts the folder of the external device containing the file in a case where the size of the file exceeds the size of the reception buffer, and does not mount the folder of the external device containing the file in a case where the size of the file does not exceed the size of the reception buffer.

### BACKGROUND OF THE INVENTION

1. Field of the Invention

The present invention relates to an image forming apparatus, image forming method, and computer-readable medium. Particularly, the present invention relates to control of the storage area of accumulated print data in an image forming apparatus.

2. Description of the Related Art

There are two methods to implement print processing for a PDL data format serving as a non-stream data format such as PDF in an image forming apparatus. One method converts non-stream data into stream data, and transfers the stream data to the image forming apparatus. The other method accumulates all non-stream data in the image forming apparatus, and performs PDL data analysis processing by accessing at random accumulated data in the image forming apparatus. The former method requires a data converter, and the latter method must ensure a storage capacity capable of accumulating an entire PDL file in the image forming apparatus. As a means for implementing an area for accumulating all data, especially in the latter method, there is proposed a system in which a network-connected external information processing apparatus is network-mounted in an image forming apparatus and used as a resource of the image forming apparatus (see Japanese Patent Laid-Open No. 2005-250742).

An image forming apparatus simultaneously receives a plurality of print jobs, and sequentially performs image formation processing in the reception order. When the image forming apparatus runs out of consumables such as paper or toner, many queued jobs having undergone PDL rasterization and RIP processing are accumulated in a job list. According to Japanese Patent Laid-Open No. 2005-250742, mounting of an external storage device in the image forming apparatus ends at the timing when printing is completed or when a timer-based period ends. In the method disclosed in Japanese Patent Laid-Open No. 2005-250742, when a plurality of jobs are input and output processing temporarily stops, print jobs incapable of releasing network mounts are considered to be generated continuously.

Network mount processing consumes the CPU and network resources. When many jobs having different reference destinations exist, file systems need to be mounted individually by the number of jobs. As the number of jobs increases, the number of network mounts increases, adversely affecting the performance of the overall image forming apparatus. To prevent this, when the image forming apparatus mounts the storage areas of different information processing apparatuses for respective jobs, the start and end timings of mounts need to be managed in accordance with the job processing status to keep the number of network mounts to be equal to or smaller than a predetermined value.

### SUMMARY OF THE INVENTION

According to one aspect of the present invention, there is provided an image forming apparatus which is connected to an external device and prints a PDL file managed in the external device, comprising: an acquisition unit configured to acquire a size of a file to be printed; a comparison unit configured to compare a size storable in a reception buffer of the image forming apparatus with the size of the file; and a network mount unit configured to mount a folder of the external device containing the file, wherein the network mount unit mounts the folder of the external device containing the file in a case where the size of the file exceeds the size of the reception buffer, and does not mount the folder of the external device containing the file in a case where the size of the file does not exceed the size of the reception buffer.

According to another aspect of the present invention, there is provided an image forming method in an image forming apparatus which is connected to an external device and prints a PDL file managed in the external device, comprising the steps of: acquiring a size of a file to be printed; comparing a size storable in a reception buffer of the image forming apparatus with the size of the file; and mounting a folder of the external device containing the file, wherein in the mount step, the folder of the external device containing the file is mounted in a case where the size of the file exceeds the size of the reception buffer, and is not mounted in a case where the size of the file does not exceed the size of the reception buffer.

According to another aspect of the present invention, there is provided a non-transitory computer-readable medium storing a program for causing a computer to function as an acquisition unit configured to acquire a size of a PDL file to be printed that is managed in an external device, a comparison unit configured to compare a size storable in a reception buffer of the computer with the size of the file, and a network mount unit configured to mount a folder of the external device containing the file, wherein the network mount unit mounts the folder of the external device containing the file in a case where the size of the file exceeds the size of the reception buffer, and does not mount the folder of the external device containing the file in a case where the size of the file does not exceed the size of the reception buffer.

The present invention can suppress consumption of the resources of an image forming apparatus by using a network-mounted external storage device as the buffer of the image forming apparatus, depending on the situation.

Further features of the present invention will become apparent from the following description of exemplary embodiments (with reference to the attached drawings).

### BRIEF DESCRIPTION OF THE DRAWINGS

FIG. 1 is a view exemplifying a network configuration including an information processing apparatus and image forming apparatus;

FIG. 2 is a block diagram exemplifying the HW arrangement of the image forming apparatus;

FIG. 3 is a block diagram exemplifying the SW arrangement of the image forming apparatus;

FIGS. 4A, 4B, and 4C are views showing PDL data flows in respective modes in the image forming apparatus;

FIGS. 5A and 5B are flowcharts showing data processing in the image forming apparatus;

FIGS. 6A and 6B are sequence charts showing internal accumulation of received data in the image forming apparatus;

FIGS. 7A, 7B, and 7C are sequence charts showing external reference of received data-release before completion of printing in the image forming apparatus;

FIGS. 8A, 8B, and 8C are sequence charts showing external reference of received data-release after completion of printing in the image forming apparatus; and

FIGS. 9A, 9B, 9C, 9D, 9E, 9F, 9G, 9H, and 91 are views exemplifying display of network mount state UI screens in the image forming apparatus.

### DESCRIPTION OF THE EMBODIMENTS

Embodiments of the present invention will now be described with reference to the accompanying drawings.

<System Configuration>

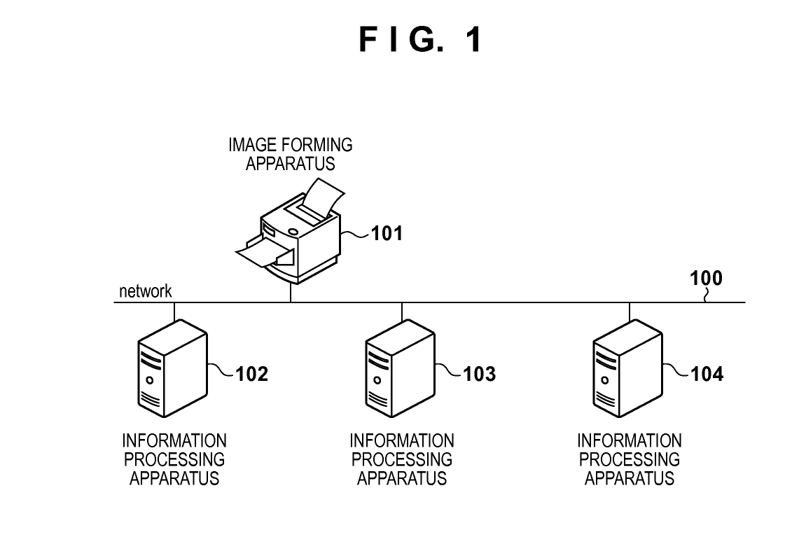

FIG. 1 is a view showing a system configuration in the present invention. Information processing apparatuses 102 to 104 and an image forming apparatus 101 according to the embodiment are connected via a network 100. The information processing apparatuses 102 to 104 serving as external devices connected via the network are SMB (Server Message Block) file servers which store PDL (Page Description Language) print data such as PDF (Portable Document Format) data. The information processing apparatuses 102 to 104 manage data to be printed. The image forming apparatus 101 accesses the file servers of the information processing apparatuses 102 to 104, browses, selects, and acquires a file to be printed, and performs print processing. The embodiment exemplifies three information processing apparatuses functioning as file servers. However, the present invention is not limited to this, and the number of information processing apparatuses is increased/decreased, as needed.

[Hardware Arrangement]

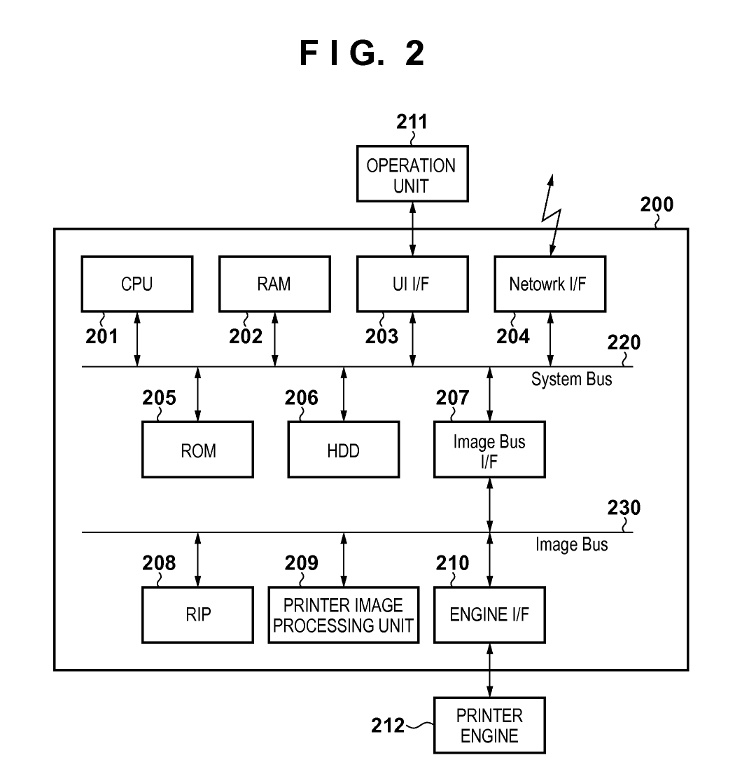

FIG. 2 is a block diagram exemplifying the hardware of the image forming apparatus 101 according to the embodiment. A CPU 201, RAM 202, UI I/F 203, network I/F 204, ROM 205, and HDD 206 are connected to a system bus 220. The respective components can communicate with each other. The components on the system bus 220 access, via an image bus I/F 207, a RIP 208, printer image processing unit 209, and printing engine I/F 210 which are connected to an image bus 230.

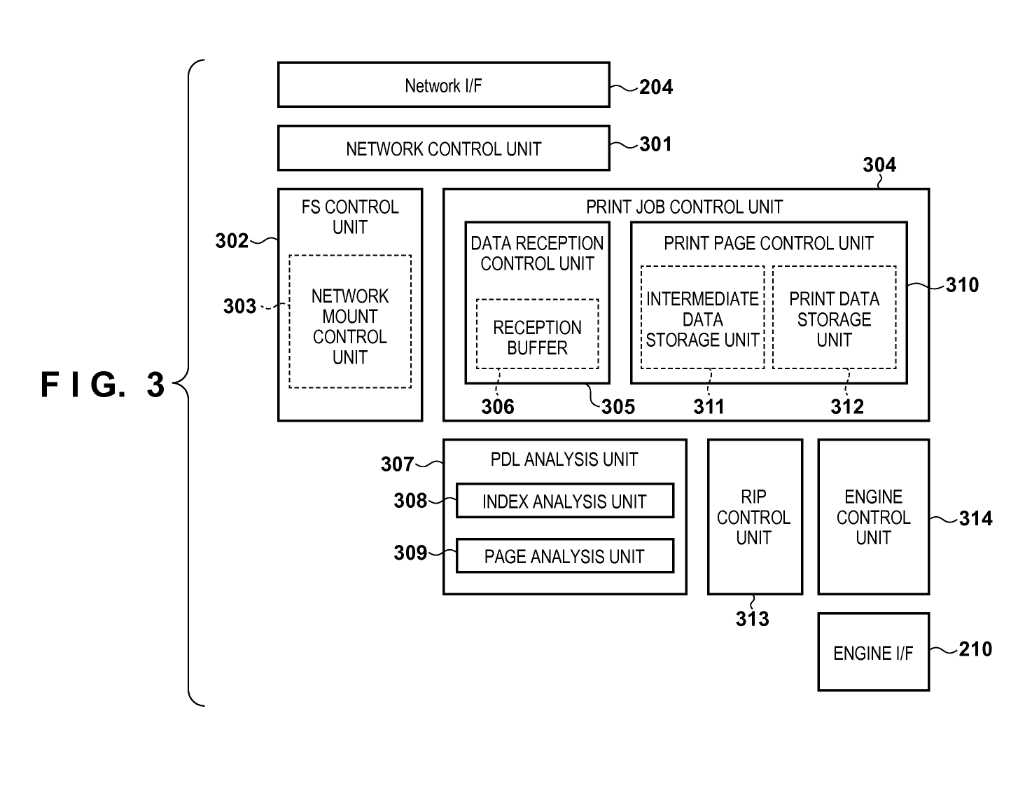

Control units shown in FIG. 3 run on the CPU 201, and the RAM 202 holds temporary data during processing. The UI I/F 203 is connected to an operation unit 211, and notifies each module of a signal from the operation unit 211. The network I/F 204 receives PDL data from the information processing apparatuses 102 to 104 via the network 100, and stores them in the HDD 206. The ROM 205 stores various parameters and programs necessary to activate and execute the image forming apparatus 101. Each software module accesses the ROM 205, as needed. Each module accesses the HDD 206 for temporary storage of PDL data received via the network 100 or as the data swap areas of the RIP 208 and printer image processing unit 209.

The image bus I/F 207 mediates the system bus 220 and image bus 230 of the image forming apparatus 101. Also, the image bus I/F 207 mediates communication between the system bus 220 on which control system software runs, and page image processing modules running on the image bus 230. The RIP 208 connected to the image bus 230 rasterizes a PDL code as intermediate data. The printer image processing unit 209 performs resolution conversion and correction processing corresponding to the printer engine 212 for an image file generated by the RIP 208. The engine I/F 210 is a communication I/F for controlling a printer engine 212 by an engine control unit 314 via the engine I/F 210.

[Software Arrangement]

FIG. 3 is a block diagram exemplifying the software arrangement of the image forming apparatus 101 according to the embodiment. The network I/F 204 provides a TCP/IP socket I/F to a network control unit 301. The network control unit 301 complies with an SMB server/client protocol, and provides a means for accessing the SMB server directories of the information processing apparatuses 102 to 104 by the image forming apparatus 101. A print job control unit 304 runs on the CPU 201, and controls printing by referring to data in the RAM 202 and temporary data held in the HDD 206.

An FS control unit 302 controls cooperation with an information processing apparatus serving as a file system. A network mount control unit 303 performs control to mount, via the network, the folders of the information processing apparatuses 102 to 104 serving as file servers (to be referred to as network mount hereinafter).

In printing by referring to files managed in the information processing apparatuses 102 to 104, which of a pull print mode and network mount mode is used to operate is determined from print file information and print conditions. In the pull print mode, the image forming apparatus 101 operates using a data reception control unit 305 and reception buffer 306. In the network mount mode, the network mount control unit 303 is activated in cooperation with the FS control unit 302 to handle external files in the information processing apparatuses 102 to 104 virtually as internal files. Both the pull print mode and network mount mode use the HDD 206 and RAM 202 as the reception buffer 306 serving as the primary buffer of received data.

A PDL analysis unit 307 is a module which runs on the CPU 201 and analyzes an externally received PDF file. The PDL analysis unit 307 is formed from an index analysis unit 308 and page analysis unit 309. The index analysis unit 308 is a module which detects and analyzes PDF index information in a PDF file. The index analysis unit 308 notifies the print job control unit 304 of the total page count of the PDF file. The page analysis unit 309 performs PDL rasterization processing in accordance with a PDL command in the PDF file, generating intermediate page data. The generated intermediate page data is stored in an intermediate data storage unit 311 in a print page control unit 310 on the HDD 206. A RIP control unit 313 reads out intermediate page data in the intermediate data storage unit 311 on the HDD 206, performs RIP processing using the module of the RIP 208, and writes the processed data as print data in a print data storage unit 312.

The engine control unit 314 reads out print data from the print data storage unit 312, and executes image formation processing of the printer engine 212 via the engine I/F 210. The print page control unit 310 performs PDL rasterization processing of the PDL analysis unit 307, RIP processing of the RIP control unit 313, and page print processing of the engine control unit 314 as preceding operations as asynchronously as possible. The preceding operation indicates an operation of performing processing when it becomes possible, regardless of successive processing and the like. Note that processing at a preceding stage may temporarily stop depending on the state of the data storage unit or the like. For example, the PDL analysis unit 307 can operate to precede the RIP control unit 313 unless the area of the intermediate data storage unit 311 runs out. Similarly, the RIP control unit 313 can execute RIP processing beforehand unless the print data storage unit 312 runs out of space.

<Data Processing Sequence>

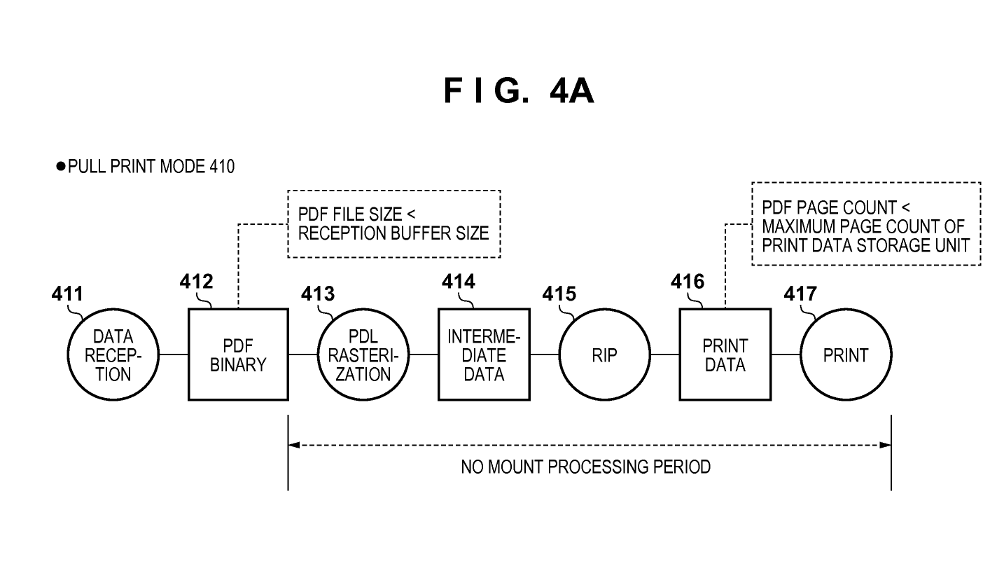

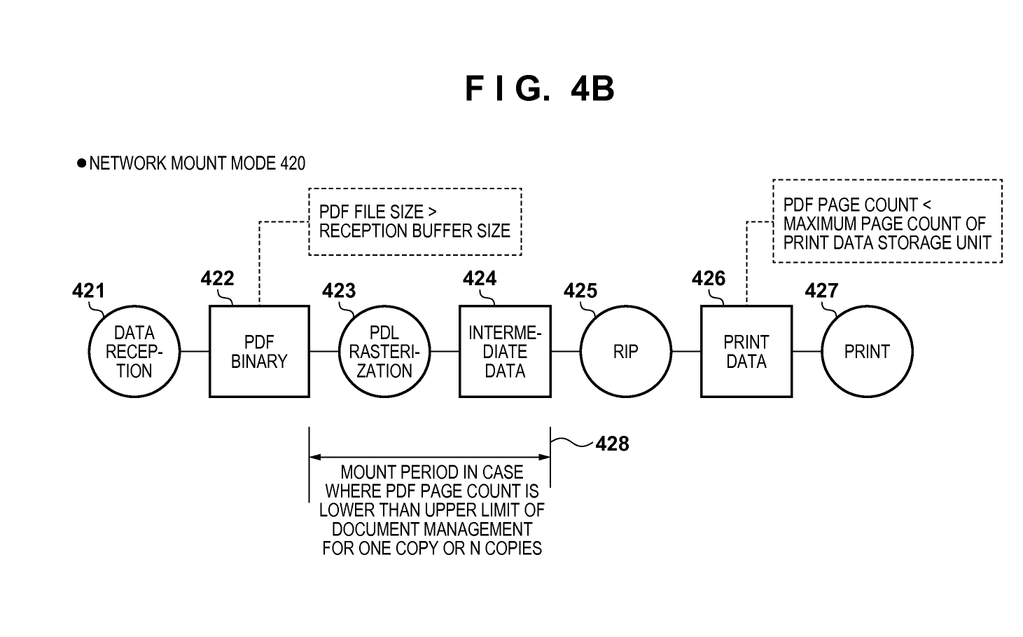

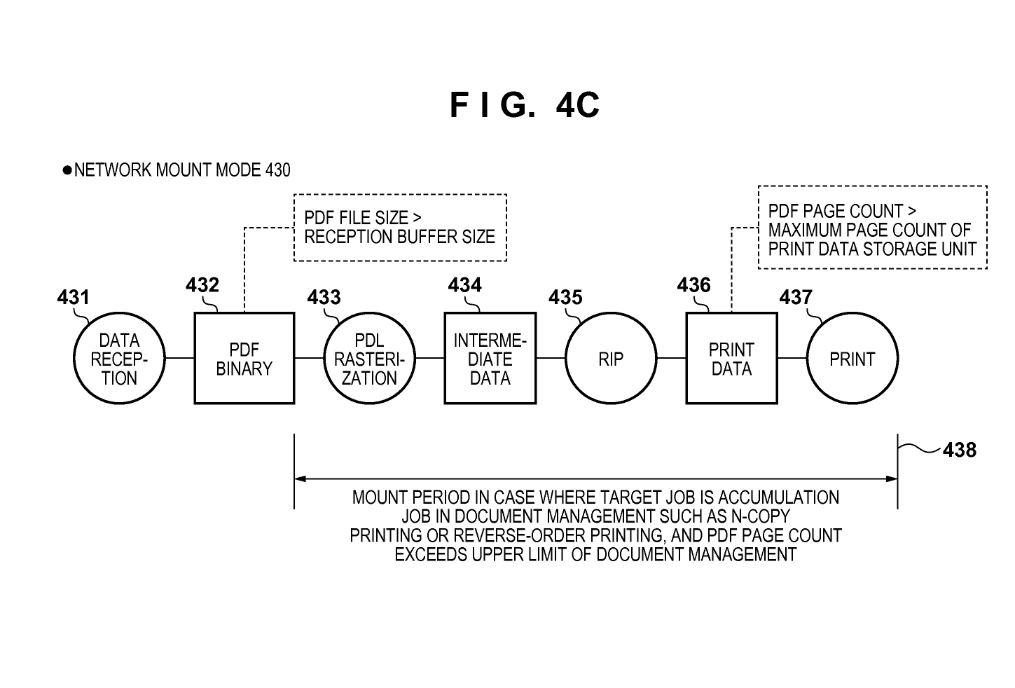

Data processing sequences corresponding to respective modes will be explained with reference to FIGS. 4A to 4C. FIG. 4A shows a case where printing is performed in the pull print mode. FIGS. 4B and 4C show cases where printing is performed in the network mount mode.

A pull print mode 410 shown in FIG. 4A represents the flow of a general network print operation. First, the image forming apparatus 101 accesses the information processing apparatuses 102 to 104 serving as SMB clients, and confirms PDF file sizes. After confirming that a condition “PDF file size<the size of the reception buffer 306” is established, the image forming apparatus 101 performs data reception 411, and stores a PDF file in the reception buffer 306. This mode indicates that the entire PDF file to be printed can be stored in the reception buffer 306 of the image forming apparatus.

After that, the image forming apparatus 101 controls the page analysis unit 309 to perform PDL rasterization processing 413 for a received file 412. The image forming apparatus 101 controls the RIP control unit 313 to perform RIP processing 415 for intermediate data 414 generated by the PDL rasterization processing 413. Then, the image forming apparatus 101 controls the engine control unit 314 to perform print processing 417 for print data 416 generated by the RIP processing 415. At this time, the intermediate data 414 is stored in the intermediate data storage unit 311, and the print data 416 is stored in the print data storage unit 312. If each data temporarily overflows, the sequence advances to processing at a subsequent stage, and processing at a preceding stage temporarily stops until each area where data is stored is released.

Network mount modes 420 and 430 shown in FIGS. 4B and 4C are reception print operations when the reception buffer 306 of the image forming apparatus 101 is not large enough for the data mount of a PDF file to be printed. Similar to the pull print mode 410, the image forming apparatus 101 accesses the information processing apparatuses 102 to 104 serving as SMB clients, and confirms PDF file sizes. When the PDF file size exceeds the size of the reception buffer 306, the entire PDF file to be printed cannot be received, so the information processing apparatus serving as an SMB server is network-mounted. In each processing, a necessary data range is partially cached in the RAM 202 of the image forming apparatus 101.

As for the network mount mode, the difference between FIGS. 4B and 4C is the timing for releasing a network mount. In the network mount mode 420 of FIG. 4B, a network mount is released when PDL rasterization processing 423 for a PDF file has ended for all the pages of the PDF file and intermediate data 424 is stored in the intermediate data storage unit 311. In the network mount mode 430 of FIG. 4C, a network mount is released upon completion of print processing 437.

The network mount mode 430 is selected when all print page data are generated from data of an original PDF file by a plurality of times. For example, the network mount mode 430 is selected when the page count of a PDF file exceeds a page count storable in the print data storage unit 312 and printing of a plurality of copies is designated.

<Switching of Mode and Release of Network Mount>

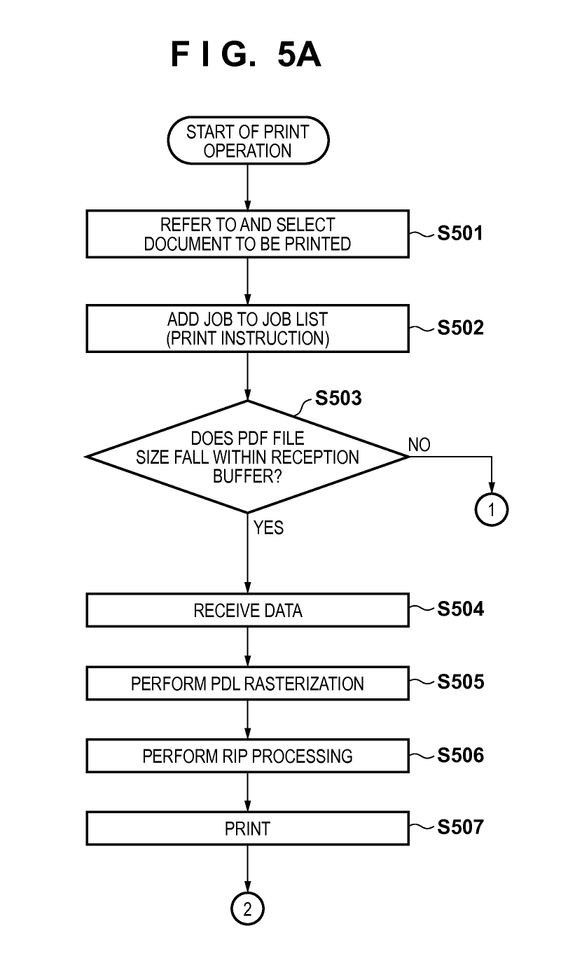

FIGS. 5A and 5B show a sequence to determine switching between the pull print mode and the network mount mode and determine release of a network mount. Note that this processing sequence is implemented by reading out a program stored in the HDD 206 or the like serving as a storage unit, and executing it by the CPU 201 of the image forming apparatus 101.

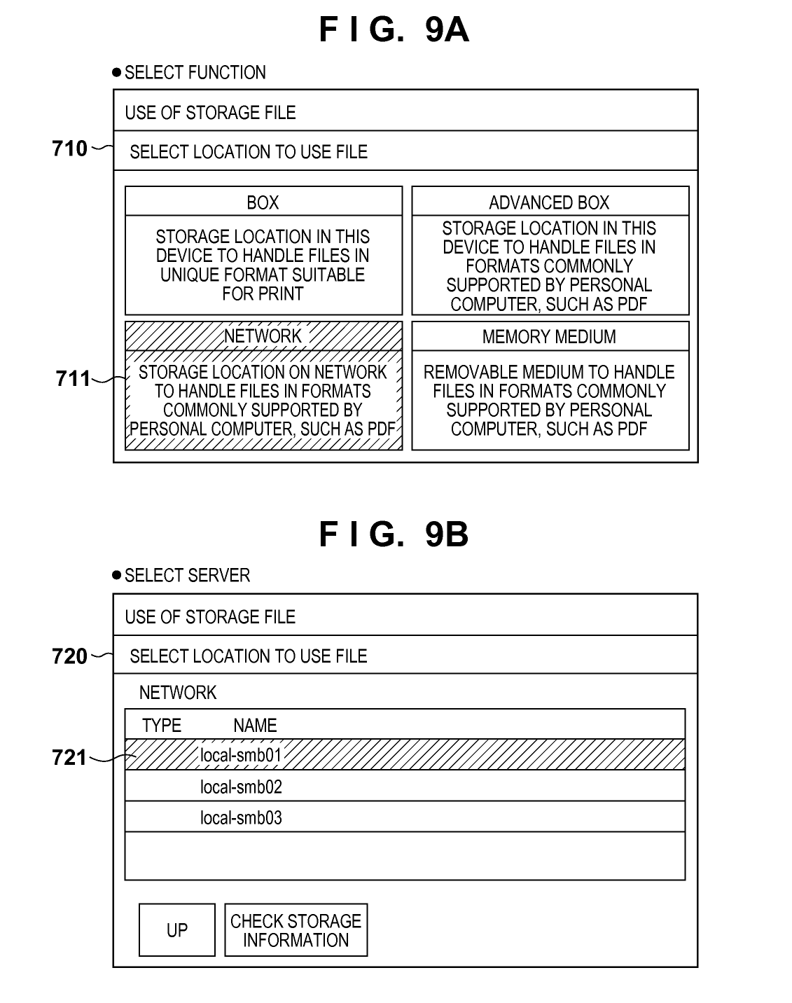

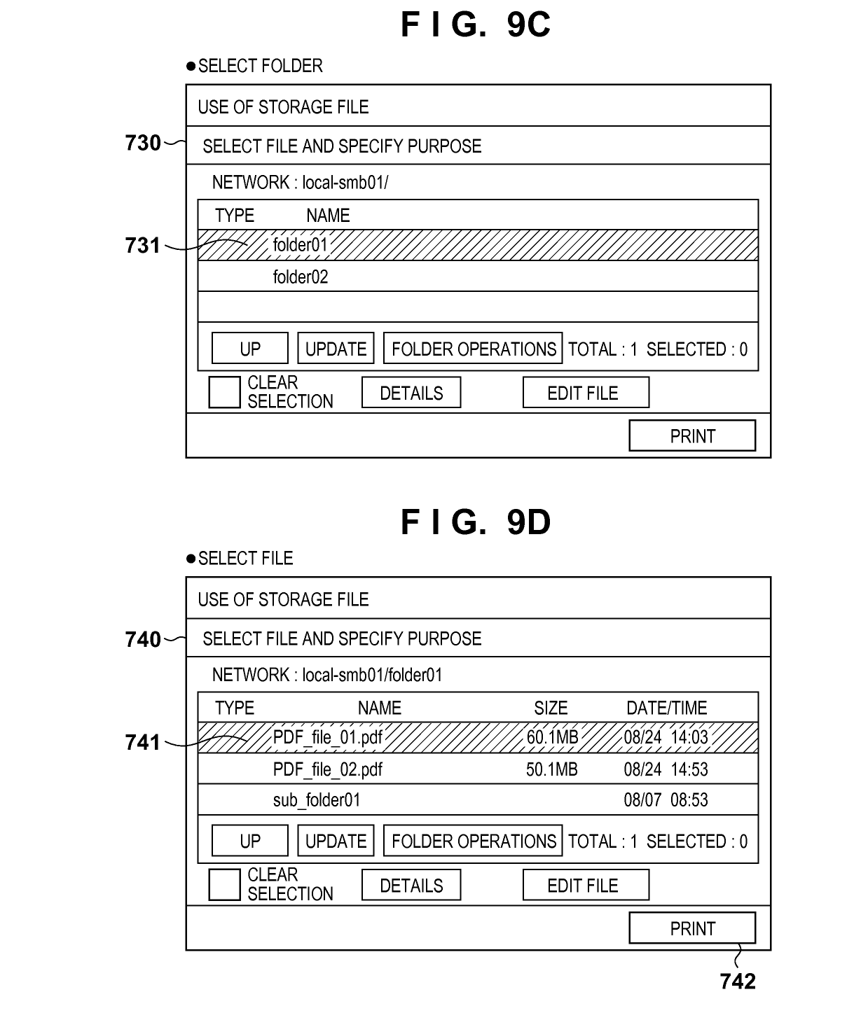

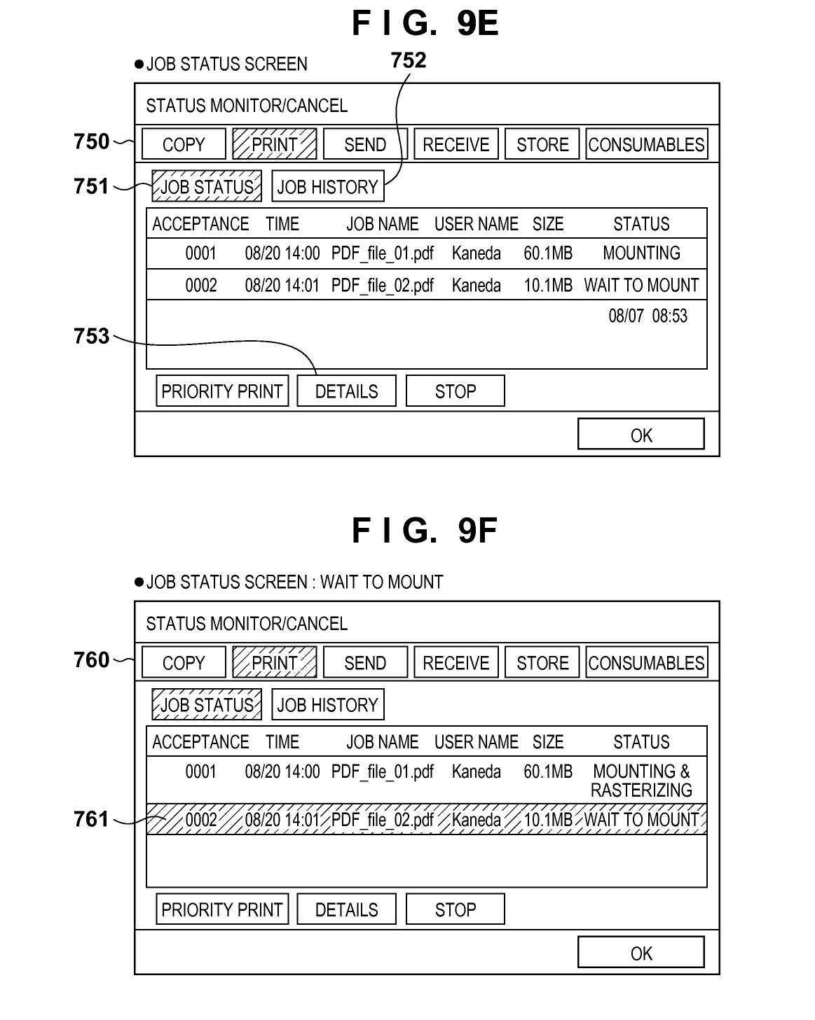

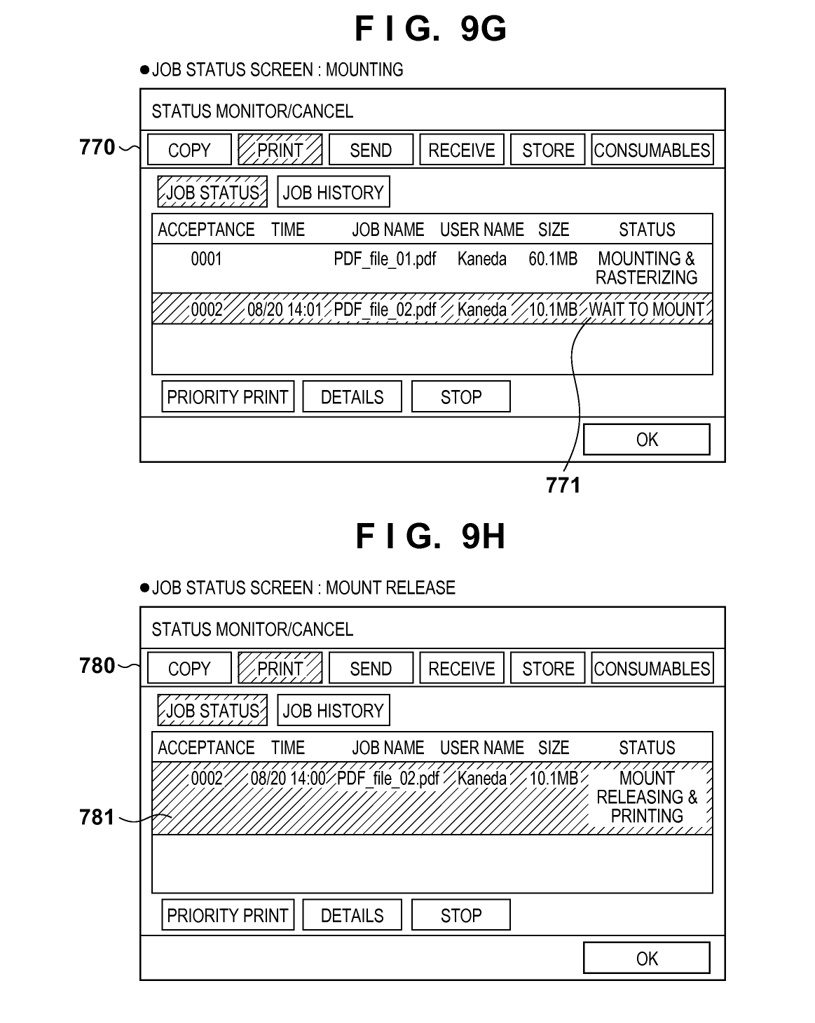

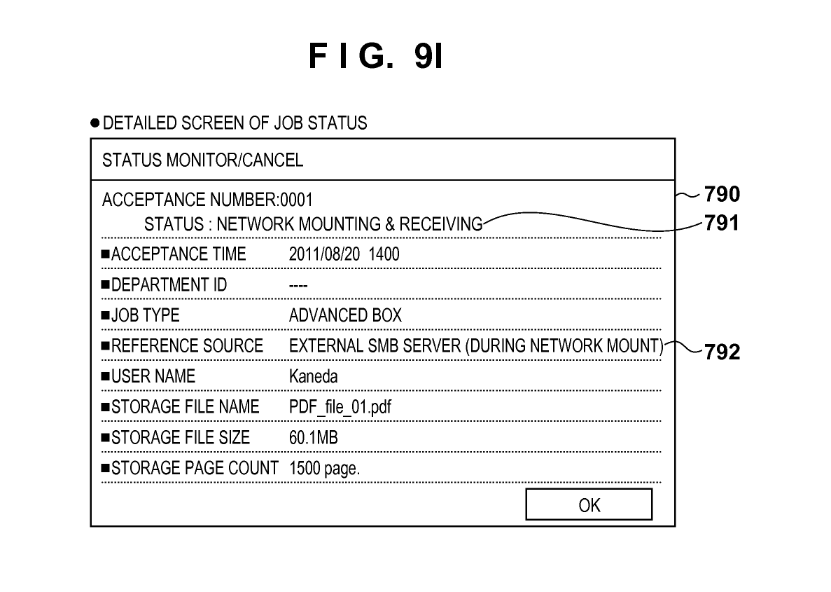

In step S501, the user browses files in the information processing apparatuses 102 to 104 from UI screens shown in FIGS. 9A to 9I, and selects a file to be printed. The UI screen will be described in more detail with reference to FIGS. 9A to 9I. Screens 710 to 740 in FIGS. 9A to 9D correspond to file selection at this time. In step S502, the image forming apparatus 101 accepts pressing of a print button 742 from the user via the file selection screen 740 to print a selected PDF file 741.

In step S503, the print job control unit 304 confirms, from a corresponding one of the information processing apparatuses 102 to 104 via the network control unit 301, the file size of the PDF file selected in step S502. If the file size falls within the reception buffer 306 (YES in step S503), the process advances to step S504. If the file size exceeds the reception buffer 306 (NO in step S503), the process advances to step S508. Steps S504 to S507 correspond to the pull print mode shown in FIG. 4A. In step S504, the data reception control unit 305 receives a PDF file in a corresponding one of the information processing apparatuses 102 to 104, and copies it in the reception buffer 306 in cooperation with the SMB client function of the network control unit 301.

In step S505, the print job control unit 304 instructs the PDL analysis unit 307 to start PDL rasterization processing for the PDF file transferred to the reception buffer. Then, the PDL analysis unit 307 generates intermediate page data from data of the PDF file. In step S506, the RIP control unit 313 performs RIP processing for the generated intermediate page data, generating print data. In step S507, the engine control unit 314 transfers the RIPed print data to the printer engine 212, executing print processing. Thereafter, the processing sequence ends.

In step S508, the print job control unit 304 confirms whether a network mount for a preceding job has been released. In the embodiment, the number of network mounts is defined in advance as a threshold in the confirmation. If the number of network mounts is equal to or smaller than the threshold, the print job control unit 304 determines to execute a network mount. If the preceding job remains network-mounted (NO in step S508), the process waits until the number of network mounts becomes equal to or smaller than the threshold. If the network mount of the preceding job has been released, that is, the number of network mounts is equal to or smaller than the threshold (YES in step S508), the process advances to step S509. Note that the threshold is set for the number of network mounts to make a determination based on the threshold in step S508, but the present invention is not limited to this. For example, a threshold such as the load factor of the CPU may be set to make a determination based on this threshold.

In step S509, the print job control unit 304 instructs the network mount control unit 303 via the FS control unit 302 to network-mount a target folder of the information processing apparatus for the current job. At this time, the information processing apparatus to be network-mounted stores a PDF file corresponding to the job ID of the job selected in step S502.

In step S510, the print job control unit 304 inquires the total page count of the PDF file, of the index analysis unit 308 of the PDL analysis unit 307. The print job control unit 304 compares the acquired total page count of the PDF file with a page count storable in the print data storage unit 312 of the print page control unit 310. At this time, if the print data storage unit 312 cannot accumulate all the pages of the PDF file, the print job control unit 304 confirms the finishing conditions (print settings regarding finishing) of the print job, and determines whether print processing is necessary while accumulating all pages. This confirmation is not limited to print settings regarding finishing, and print settings requiring accumulation of all pages may be confirmed.

Examples of finishing conditions to be confirmed are multiple-copy printing, bookbinding printing, and reverse-order printing. In multiple-copy printing, bookbinding printing, and reverse-order printing, all the pages of a print job need to be accumulated in the print data storage unit 312 till the end of PDL rasterization processing and RIP processing.

In multiple-copy printing, PDL rasterization processing and RIP processing are executed only for the first copy, and print processing is performed by a plurality of times, outputting a plurality of copies while shortening the processing time. This is implemented only when the print data storage unit 312 can accumulate all the pages of a PDF file. If the print data storage unit 312 has a small cache size and cannot store all the pages of a PDF file, PDL re-rasterization processing and RIP re-processing are necessary for page data which have been lost due to a cache overflow.

In bookbinding printing, similar to multiple-copy printing, after all print pages having undergone PDL rasterization processing and RIP processing are cached, “page order change”, “2up”, and “double-sided printing” are performed. When performing bookbinding processing for 8-page PDF data, 2up processing is executed in the page order of “⅛”, “ 2/7”, “ 3/6”, and “⅘”. When the cache of the print data storage unit 312 is insufficient and pages overflow, regeneration processing is necessary for only the overflowing pages. For example, when the print data storage unit 312 can store only 6 pages, PDL re-rasterization processing and RIP re-processing are required for two pages overflowing from the cache.

In reverse-order processing, pages stored in the print data storage unit 312 are output from the final page. When all pages are not stored in the print data storage unit 312, PDL re-rasterization processing and RIP re-processing are necessary for overflowing pages.

When “printing after accumulating all pages” is necessary in multiple-copy printing, bookbinding printing, reverse-order printing, or the like, and “page count of a PDF file>storable page count of print data”, the print data storage unit 312 cannot store all pages necessary to print a job. Hence, the print data storage unit 312 needs to be used as a cache. When no target page remains in the print data storage unit 312 in printing, PDL rasterization processing and RIP processing are performed to regenerate the target page. The PDL analysis unit 307 requires a network-mounted PDF file till the completion of printing an entire job. In this case, processing is executed in the network mount mode 430 shown in FIG. 4C.

If the conditions in step S510 are satisfied (YES in step S510), the print job control unit 304 performs PDL rasterization processing, RIP processing, and print processing (Steps S516 to S518) for data stored in the print data storage unit 312. In step S519, the print job control unit 304 performs final copy determination processing. At this time, the print job control unit 304 determines whether the final copy of the job to be processed has been printed. If printing of the final copy has not been completed (NO in step S519), the process returns to step S516, and the print job control unit 304 repeats processing for the remaining copies. If printing of the final copy has been completed (YES in step S519), the process advances to step S520. In step S520, the print job control unit 304 releases the network mount of the target folder. Then, the processing sequence ends.

Even when “accumulation of all pages” is necessary, if “page count of a PDF file<storable page count of print data”, the print data storage unit 312 has stored RIPed image data of all pages. Thus, neither PDL rasterization processing nor RIP processing need be executed again. In this case, processing is performed in the network mount mode 420 shown in FIG. 4B.

If the conditions in step S510 are not satisfied (NO in step S510), PDL rasterization processing is performed for data of the job to be processed up to the final page (Steps S511 and S512). In step S513, the print job control unit 304 quickly releases the network mount of the PDF file. The print job control unit 304 applies RIP processing and print processing to the generated intermediate data (steps S514 and S515). Then, the processing sequence ends.

<PDF Print Operation>

(Pull Print Mode)

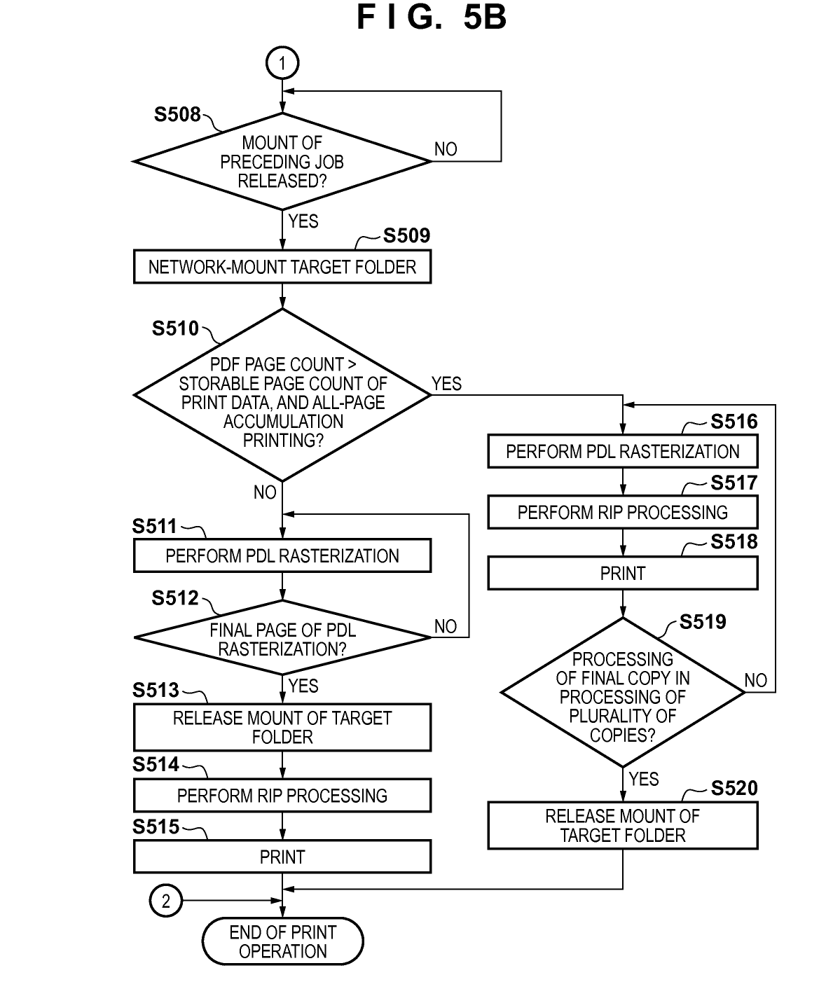

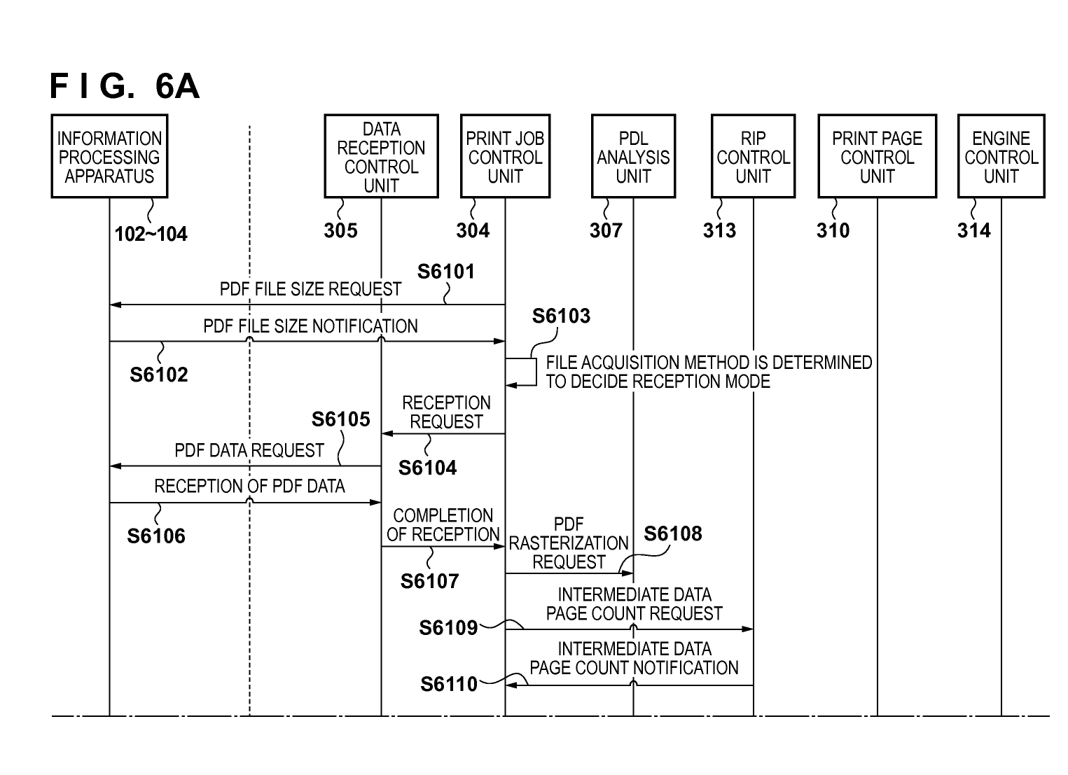

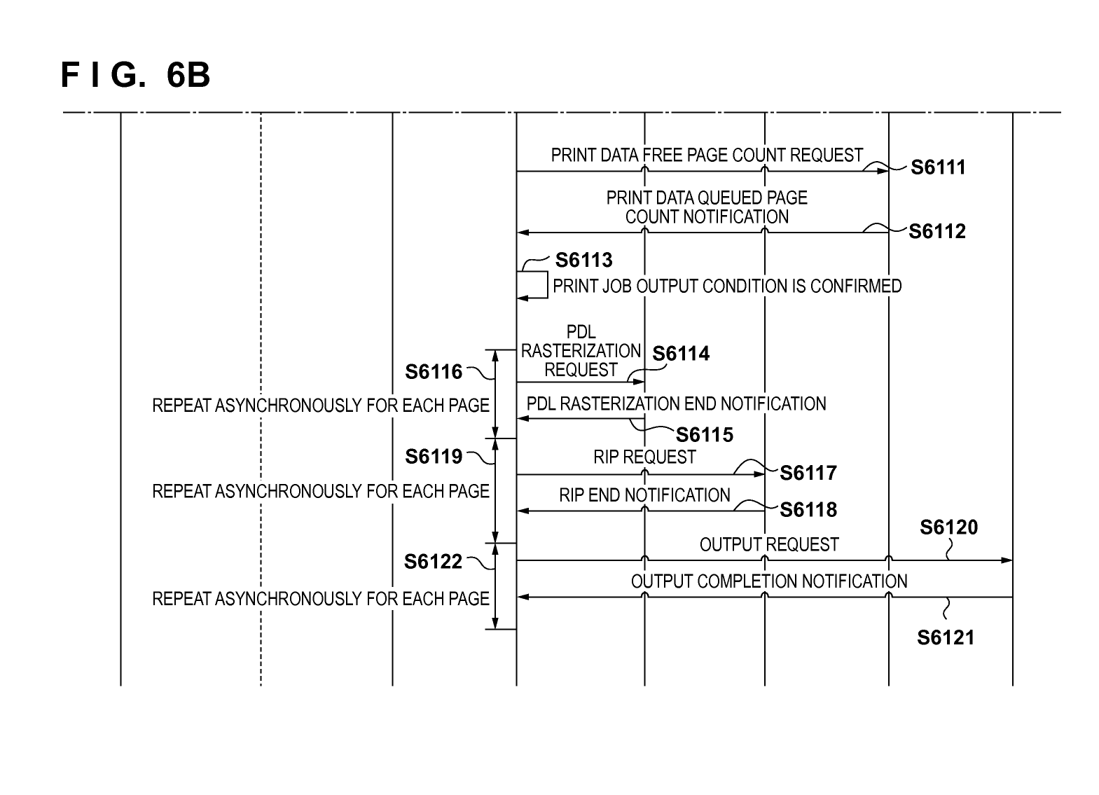

FIGS. 6A and 6B, 7A to 7C, and 8A to 8C are sequence charts each showing a PDF print operation. FIGS. 6A and 6B are sequence charts when a PDF file in the information processing apparatus is processed in the pull print mode. This sequence corresponds to the pull print mode 410 in FIG. 4A. Processing in the image forming apparatus 101 will be explained in correspondence with the processing sequence of FIGS. 5A and 5B.

In step S6101, the print job control unit 304 inquires of the information processing apparatuses 102 to 104 the file sizes of the PDF files. In step S6102, the information processing apparatuses 102 to 104 notify the image forming apparatus 101 of the file sizes of the requested PDF files as responses to the inquiry. In step S6103, the print job control unit 304 makes the determination in step S503 of FIG. 5A, and advances to step S504 (YES in step S503) to set the file acquisition method to a reception mode serving as the pull print mode. In steps S6104 to S6107, data reception processing (step S504) is performed, and the print job control unit 304 instructs the data reception control unit 305 to receive data. The data reception control unit 305 writes a PDF file received via the network 100 in the reception buffer 306. After the end of receiving data, the data reception control unit 305 notifies the print job control unit 304 with a message to this effect. After the notification, the print job control unit 304 issues a PDL rasterization request to the PDL analysis unit 307 (step S6108).

Subsequently, the print job control unit 304 confirms, from the RIP control unit 313, the page count of intermediate data waiting for RIP processing in the intermediate data storage unit 311 (steps S6109 and S6110). The print job control unit 304 determines the page count of intermediate data for which RIP processing can be preceded. PDL rasterization processing formed from steps S6114 and S6115 precedes RIP processing as long as the intermediate data storage unit 311 has free space. The PDL rasterization processing (steps S6114 and S6115) is repeated asynchronously for each page (step S6116).

Similarly, the print job control unit 304 calculates a print page count for which print processing can precede in the print data storage unit 312 (steps S6111 and S6112). RIP processing formed from steps S6117 and S6118 precedes print processing as long as the print data storage unit 312 has a free area. RIP processing (steps S6117 and S6118) is repeated asynchronously for each page. Finally, the print job control unit 304 prints, via the engine control unit 314, the print data stored in the print data storage unit 312 (steps S6120 and S6121). Print processing (steps S6120 and S6121) is repeated asynchronously for each page. Thereafter, job processing ends.

(Network Mount Mode (Release After PDL Rasterization))

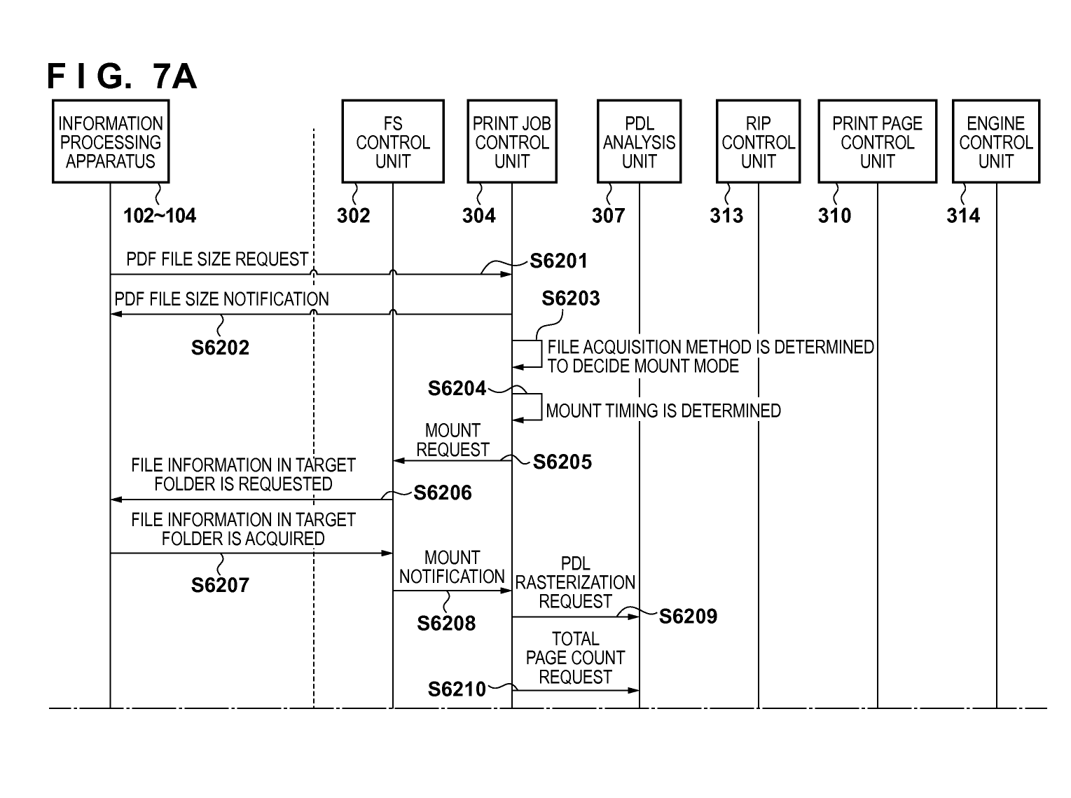

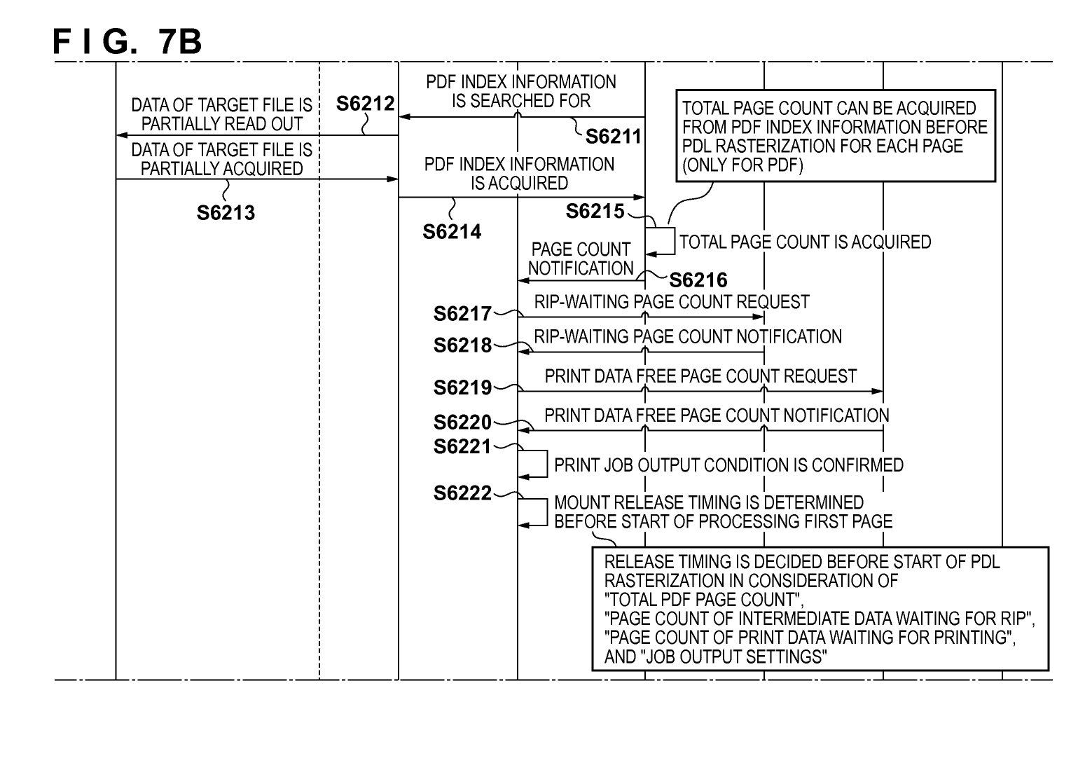

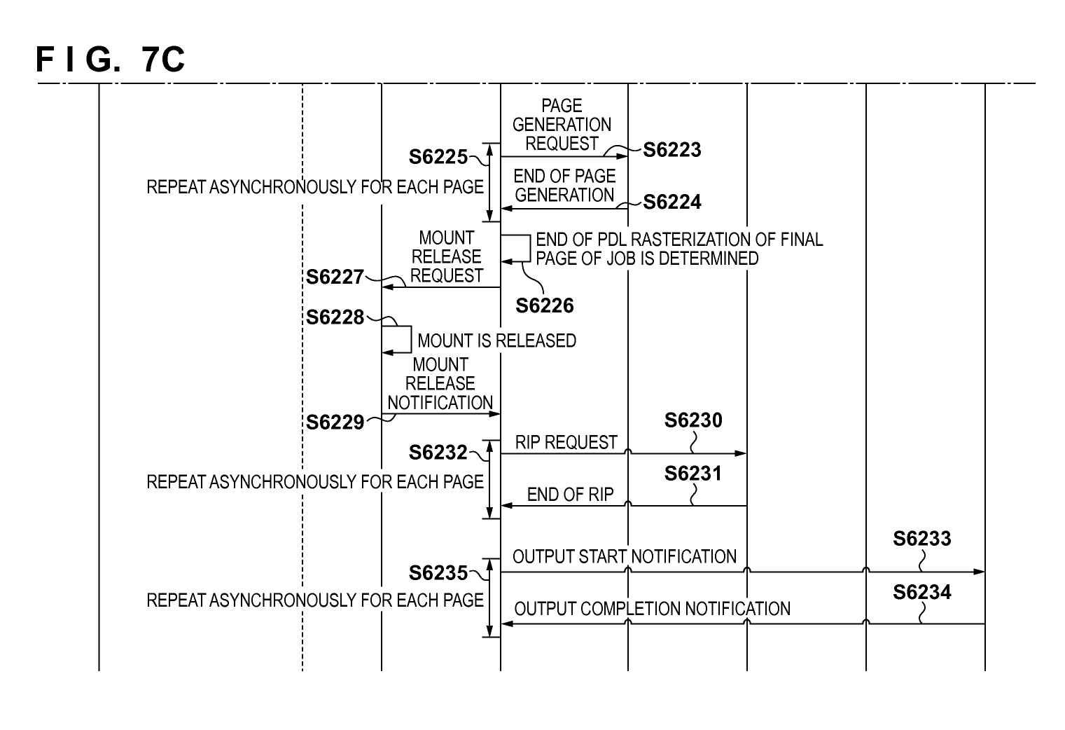

FIGS. 7A to 7C are sequence charts when a PDF file in the information processing apparatus is network-mounted (release after PDL rasterization). This sequence corresponds to the network mount mode 420 in FIG. 4B.

The image forming apparatus 101 acquires the sizes of PDF files in the information processing apparatuses 102 to 104 (steps S6201 and S6202). In step S6203, the print job control unit 304 makes the determination in step S503 of FIG. 5A, and sets an operation mode (corresponding to the network mount mode 420) in step S508. In step S6204, the print job control unit 304 waits until the number of network mounts becomes equal to or smaller than a predetermined value in accordance with the set operation mode. If the network mount of a preceding job is released, the print job control unit 304 performs mount processing in step S509 of FIG. 5B. The sequence of this mount processing corresponds to steps S6205 to S6208. After the completion of mounting, the process advances to step S511. The print job control unit 304 transmits a PDL rasterization processing start request (step S6209) and a PDF total page notification request (step S6210).

The PDL analysis unit 307 searches for index information of a PDF file while the PDF file at the network mount destination is partially cached in the reception buffer 306 of the image forming apparatus 101. The PDL analysis unit 307 acquires index information of the PDF file (steps S6211 to S6214). In step S6215, the index analysis unit 308 detects information about the total page count, and notifies the print job control unit 304 of this.

In steps S6217 and S6218, the print job control unit 304 acquires the page count of intermediate data waiting for RIP processing. In steps S6219 and S6220, the print job control unit 304 acquires the page count of print data waiting for printing. In step S6221, the print job control unit 304 checks the output conditions of the print job. If “accumulation of all print page data is unnecessary” and “total page count of a PDF file<page count waiting for printing” are satisfied, the print job control unit 304 determines to release the mount and the file after the end of PDL rasterization (step S6222). In steps S6223 and S6224, the print job control unit 304 repeats PDL rasterization processing by the page count. After it finishes analyzing all pages, the print job control unit 304 releases the network mount for the folder of the information processing apparatus containing the PDF file to be printed (steps S6227 to S6229).

Similar to the pull print mode, PDL rasterization processing, RIP processing, and print processing are repeated asynchronously for each page when the corresponding processing units can execute these processes (steps S6225, S6232, and S6235).

[Network Mount Mode (Release After Print Processing)]

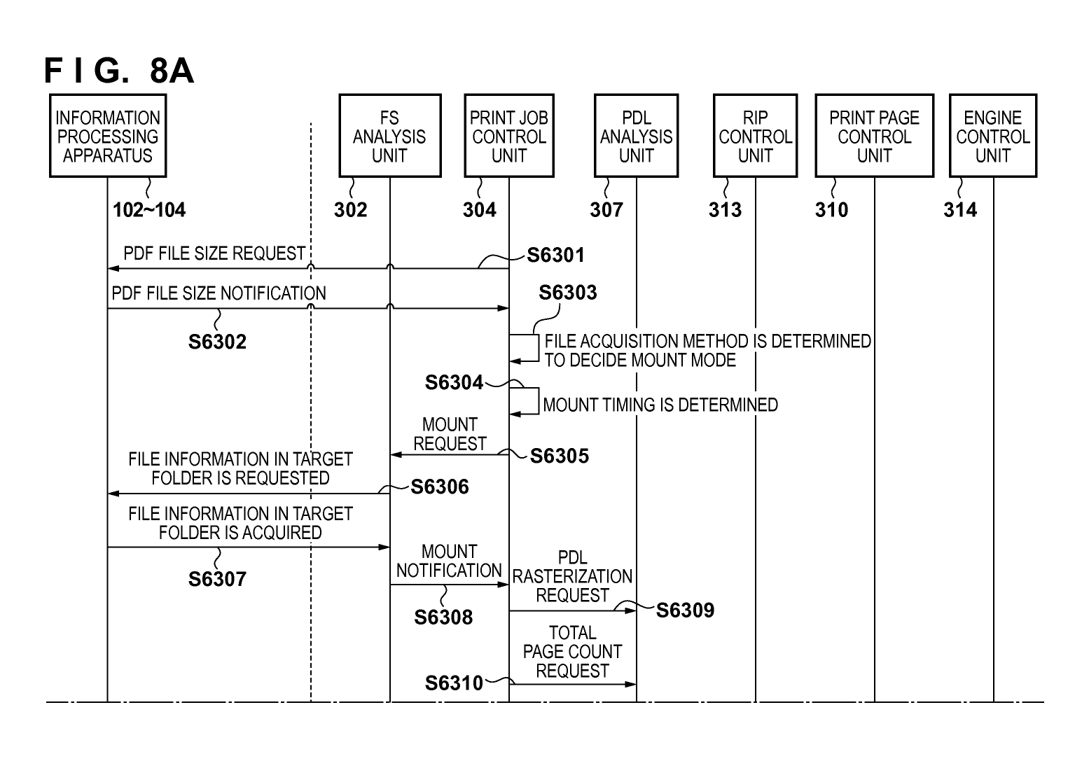

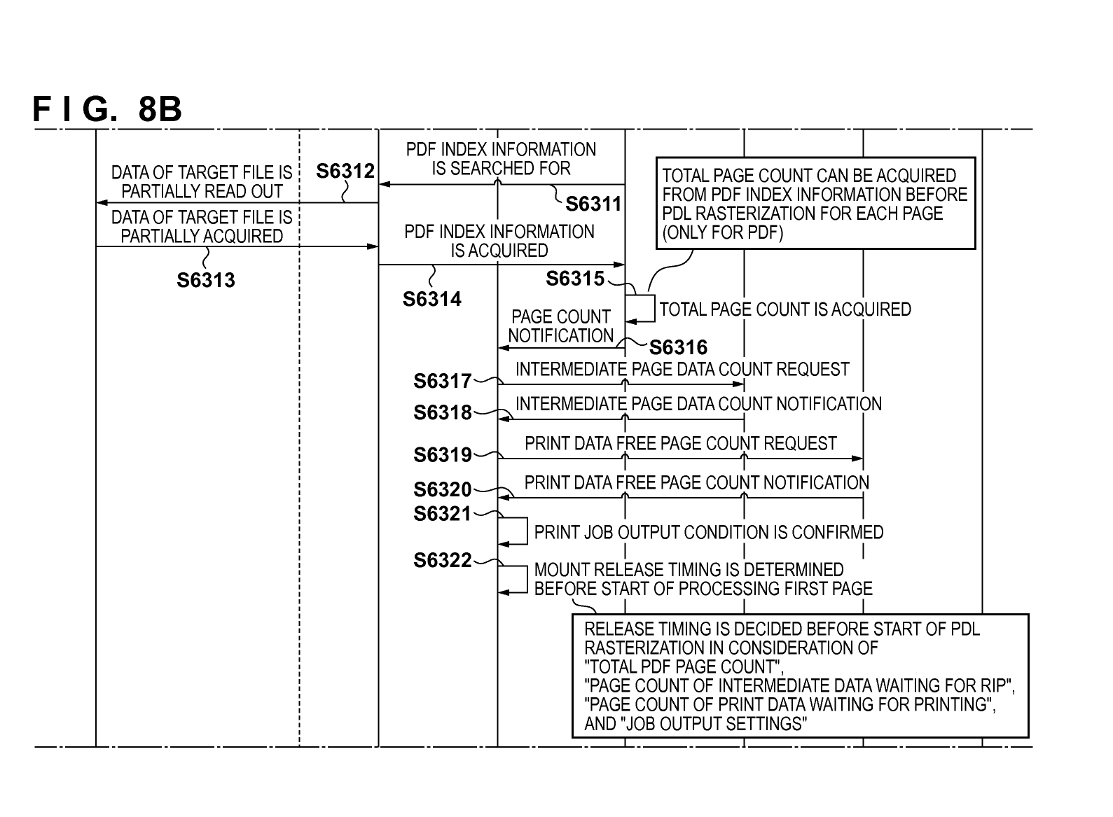

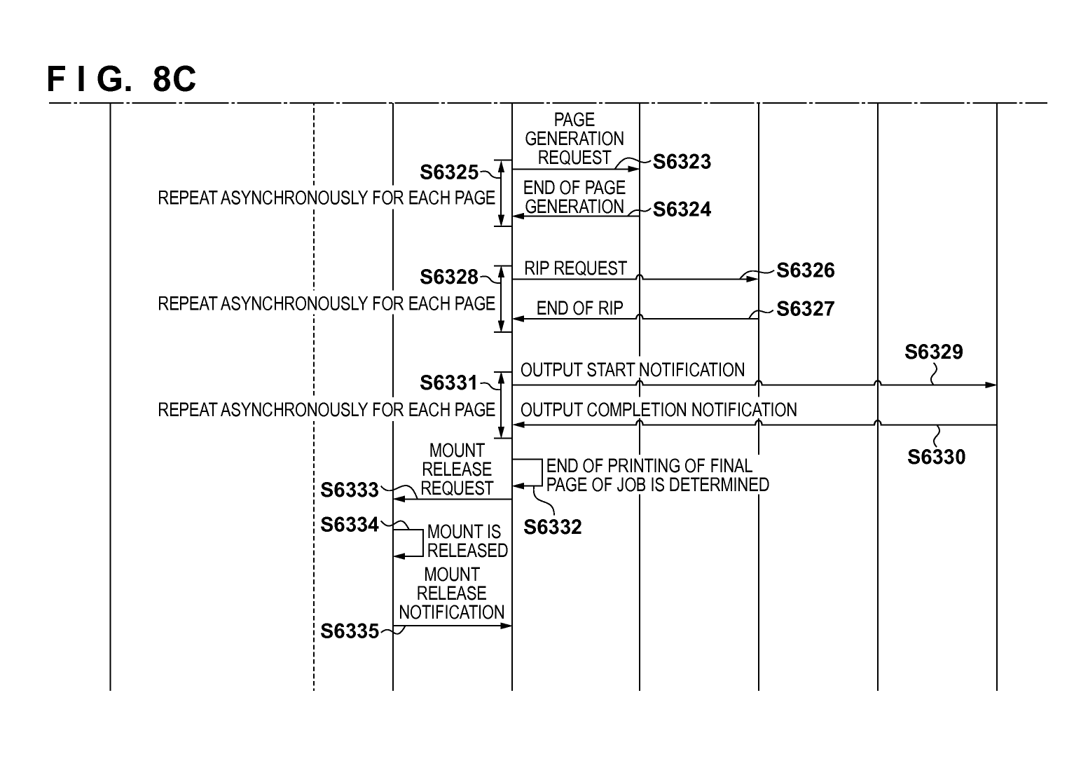

FIGS. 8A to 8C are sequence charts when a PDF file in the information processing apparatus is network-mounted (release upon completion of printing). Steps S6301 to S6320 are the same as steps S6201 to S6220 in FIG. 7B, and a description thereof will not be repeated.

In step S6321, similar to step S6221 of FIG. 7B, the output conditions of the print job are checked. If “accumulation of all page data is necessary” and “total page count of a PDF file>maximum accumulable page count waiting for printing” are satisfied, the print job control unit 304 determines to release the PDF file by releasing the network mount after the end of print processing (step S6322).

Similar to the pull print mode, PDL rasterization processing, RIP processing, and print processing are executed asynchronously for each page as long as the page storage units for respective data have free space so that the corresponding processing units can execute these processes. In the above case, the print data storage unit 312 cannot cache all the pages of a PDF file to be printed. As a difference from FIGS. 7A to 7C, when target page data is overwritten in printing, the print job control unit 304 executes PDL rasterization processing and RIP processing again. In this case, in step S6331, the print job control unit 304 confirms that printing of the final page of the job has been completed. Then, the print job control unit 304 instructs the FS control unit 302 to release the network mount (steps S6333 to S6335).

[Example of UI Screen]

FIGS. 9A to 9I show examples of UI operation screens and the flow of them in printing in the network mount mode. By selecting a choice displayed on the screen, the user can designate printing.

The selection screen 710 is a selection screen for various print functions, and is used to select the reference destination of a PDF file to be printed. The user selects a network item 711 to select a network-connected information processing apparatus. On the server selection screen 720, the user selects an information processing apparatus 721 containing a PDF file to be printed. On the folder selection screen 730, the user traces the hierarchy up to a folder 731 containing the PDF file to be printed. On the file selection screen 740 representing the contents of the target folder, the user selects the PDF file 741 to be printed, and presses the print button 742. The printing-designated PDF file is listed in a job status screen 750. On the job status screen 750, jobs waiting for printing and during printing are displayed in a job status tab 751, and printed jobs are displayed in a job history tab 752.

Each of job status screens 760 to 790 represents the network mount state of a job waiting for printing in the job list. A job 761 on the job status screen 760 waits for release of the network mount of a preceding job in step S508. A job 771 on the job status screen 770 represents a state in which a network mount in Steps S509 to S512 or S509 to S519 of FIG. 5B has started and PDL analysis processing is performed. A job 781 on the job status screen 780 represents a state in which RIP processing and print processing in Steps S514 and S515 are performed after release of a mount in step S513 of FIG. 5B.

Since print processing has ended in step S520, the job is displayed not in the job status tab but in the job history tab 752. The detail screen 790 of the job status appears when the user presses a detailed information button 753. On the detail screen 790, an item 791 represents a network mount status, and an item 792 represents information representing whether the data reference source is an external information processing apparatus or the inside of the image forming apparatus.

As described above, consumption of the resources of the image forming apparatus can be suppressed by using a network-mounted external storage device as the buffer of the image forming apparatus depending on the situation.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-223455, filed Oct. 7, 2011, which is hereby incorporated by reference herein in its entirety.

What is claimed is:

1. An image forming apparatus which is connected to an external device and prints a PDL file managed in the external device, comprising:
an acquisition unit configured to acquire a size of a file to be printed;
a comparison unit configured to compare a size storable in a reception buffer of the image forming apparatus with the size of the file; and
a network mount unit configured to mount a folder of the external device containing the file,
wherein said network mount unit mounts the folder of the external device containing the file in a case where the size of the file exceeds the size of the reception buffer, and does not mount the folder of the external device containing the file in a case where the size of the file does not exceed the size of the reception buffer.

2. The apparatus according to claim 1, further comprising a determination unit configured to determine, in accordance with a threshold for a load on the image forming apparatus, whether to mount the folder of the external device containing the file by said network mount unit.

3. The apparatus according to claim 2, wherein the threshold in said determination unit includes at least one of the number of mounts by the image forming apparatus and a load factor of a CPU.

4. The apparatus according to claim 1, further comprising a decision unit configured to, after accumulating data upon completion of PDL analysis processing and RIP processing for all pages forming file, decide, based on a print setting, whether print processing needs to start for the data,
wherein when said decision unit decides that accumulation of data of all pages is unnecessary at a start of print processing, said network mount unit releases a mount of the folder containing the file at an end of PDL analysis processing.

5. The apparatus according to claim 4, wherein when said decision unit decides that accumulation of data of all pages is necessary at a start of print processing, said network mount unit releases a mount of the folder containing the file at an end of print processing for all the pages.

6. The apparatus according to claim 4, wherein when at least one of multiple-copy printing, bookbinding printing, and reverse-order printing is designated in the print setting, said decision unit decides that accumulation of all pages is necessary.

7. The apparatus according to claim 5, wherein
said decision unit further decides whether a size of data having undergone PDL analysis processing and RIP processing for all pages forming the file is a size which can be held in a storage unit of the image forming apparatus, and
when said decision unit decides that the data can be stored in the storage unit of the image forming apparatus, said network mount unit releases a mount of the folder containing the file at an end of PDL analysis processing.

8. An image forming method in an image forming apparatus which is connected to an external device and prints a PDL file managed in the external device, comprising the steps of:
acquiring a size of a file to be printed;
comparing a size storable in a reception buffer of the image forming apparatus with the size of the file; and
mounting a folder of the external device containing the file,
wherein in the mount step, the folder of the external device containing the file is mounted in a case where the size of the file exceeds the size of the reception buffer, and is not mounted in a case where the size of the file does not exceed the size of the reception buffer.

9. A non-transitory computer-readable medium storing a program for causing a computer to function as
an acquisition unit configured to acquire a size of a PDL file to be printed that is managed in an external device,
a comparison unit configured to compare a size storable in a reception buffer of the computer with the size of the file, and
a network mount unit configured to mount a folder of the external device containing the file,
wherein said network mount unit mounts the folder of the external device containing the file in a case where the size of the file exceeds the size of the reception buffer, and does not mount the folder of the external device containing the file in a case where the size of the file does not exceed the size of the reception buffer.
